(19) United States
(12) Patent Application Publication
(10) Pub. No.: US 2026/0229585 A1
(43) Pub. Date: Aug. 6, 2026

(54) ELECTROCHEMICAL DEVICE AND ELECTRONIC DEVICE

(71) Applicant: Ningde Amperex Technology Limited, Ningde (CN)

(72) Inventors: Zichun CUI, Ningde (CN); Wei LIU, Ningde (CN); Xiaolong LI, Ningde (CN)

(73) Assignee: Ningde Amperex Technology Limited, Ningde (CN)

(21) Appl. No.: 19/530,426

(22) Filed: Feb. 5, 2026

(30) Foreign Application Priority Data
Feb. 5, 2025 (CN) 202510130529.3

(51) Int. Cl. H01M 10/0525; H01M 4/02; H01M 4/36; H01M 10/0587; H01M 50/46; H01M 50/489

(52) U.S. Cl. CPC H01M 10/0525; H01M 4/36; H01M 10/0587; H01M 50/461; H01M 50/489; H01M 2004/028

(57) ABSTRACT

An electrochemical device includes a positive electrode sheet, a negative electrode sheet, and a separator. The positive electrode sheet includes a positive electrode current collector and a positive electrode material layer disposed on at least one surface of the positive electrode current collector, where the positive electrode material layer includes a positive electrode active material. The positive electrode sheet is provided with a plurality of protrusions spaced apart from each other. A height of the protrusions is H m, 20≤H≤80; a radius of the each protrusions is R mm, 0.3≤R≤10; a surface area of the each protrusions is S mm², 0.08≤S≤2.51; and the protrusions are formed by a portion of the positive electrode sheet protruding on one side along the thickness direction.

### CROSS-REFERENCE TO RELATED APPLICATION

This application claims priority to the Chinese Patent Application Serial No. 202510130529.3, filed on Feb. 5, 2025, the content of which is incorporated herein by reference in its entirety.

### TECHNICAL FIELD

The present application relates to the field of electrochemical technology, and in particularly, to an electrochemical device and an electronic device.

### BACKGROUND

In the field of secondary battery manufacturing technology, a separator is a critical component positioned between the positive and negative electrodes of a secondary battery. It serves to isolate the positive and negative electrodes, preventing internal short circuits in the secondary battery. However, the adhesion between the separator and the positive electrode sheet significantly affects the performance of the battery. Poor adhesion between the separator and the positive electrode sheet may lead to issues such as electrolyte leakage and increased internal resistance during the use of the secondary battery, thereby impacting the service life and safety of the secondary battery.

Currently, efforts to improve the adhesion between the separator and the positive electrode sheet primarily focus on enhancing separator materials or optimizing manufacturing processes. For instance, specific additives are incorporated into the positive electrode sheet, or the surface of the separator is coated to improve the surface properties of the separator, making it easier to bond with the electrode sheet. Another approach involves optimizing manufacturing processes, such as thermal lamination techniques, to enhance the adhesion between the electrode sheet and the separator. While these methods have improved the adhesion between the separator and the positive electrode sheet to some extent, challenges and limitations persist. Existing technical solutions may increase the internal resistance of the secondary battery and reduce the energy density of the secondary battery. Therefore, there is an urgent need to address the issue of poor cycling performance caused by inadequate adhesion between the positive electrode sheet and the separator in secondary batteries.

### SUMMARY OF THE INVENTION

The purpose of the present application is to provide an electrochemical device and an electronic device to improve the adhesion between the positive electrode sheet and the separator, reduce internal resistance, and improve the cycling performance of the electrochemical device.

It should be noted that, in the summary of the invention of the present application, a lithium-ion battery is used as an example of a secondary battery to explain the present application. However, the secondary battery of the present application is not limited to lithium-ion batteries. The specific technical solutions are as follows:

A first aspect of the present application provides an electrochemical device, which includes a positive electrode sheet, a negative electrode sheet, and a separator. The positive electrode sheet includes a positive electrode current collector and a positive electrode material layer disposed on at least one surface of the positive electrode current collector, where the positive electrode material layer includes a positive electrode active material. The positive electrode sheet is provided with a plurality of protrusions spaced apart from each other. A height of the protrusions is H m, 20≤H≤80; a radius of the protrusions is R mm, 0.3≤R≤10; a surface area of the protrusions is S mm², 0.08≤S≤2.51; and the protrusions are formed by a portion of the positive electrode sheet protruding on one side along the thickness direction. The electrochemical device with the above structure can increase the contact area between the separator and the positive electrode sheet, improve the adhesion force between the separator and the positive electrode sheet, reduce the possibility of cycling capacity drop issues, and thereby improve the cycling performance of the electrochemical device. The structural parameters of the protrusions within the scope of the present application can reduce damage caused by the protrusions to the separator and the positive electrode sheet, lower the risk of electrolyte leakage and increased internal resistance, and improve the service life and safety performance of the electrochemical device.

In an embodiment of the present application, 0.3≤R≤8. By controlling the radius of the protrusions within the scope of the present application, the cycling performance, service life, and safety performance of the electrochemical device are further improved.

In an embodiment of the present application, the spacing between two adjacent protrusions is L mm, 0.5 mm≤L≤4 mm. By controlling the spacing L between two adjacent protrusions within the scope of the present application, damage caused by the protrusions to the separator and the positive electrode sheet is reduced, while the positive electrode sheet maintains sufficient strength, lowering the risk of electrolyte leakage and further improving the service life and safety performance of the electrochemical device. Additionally, it increases the contact area between the separator and the positive electrode sheet, enhances the adhesion force between the separator and the positive electrode sheet, reduces the possibility of cycling capacity drop issues, and further improves the cycling performance of the electrochemical device.

In an embodiment of the present application, the separator includes a base film, a ceramic layer, and a bonding layer, where the ceramic layer is located between the base film and the bonding layer, and the thickness of the bonding layer is h μm, 0.7≤h/S≤40. By controlling the thickness h of the bonding layer within the scope of the present application, the liquid retention capacity of the separator can be improved, the uniformity of electrolyte distribution can be improved, and the stiffness of the separator can be improved, thereby increasing the contact area between the separator and the protrusions of the positive electrode sheet, enhancing the adhesion force between the separator and the positive electrode sheet, further improving the cycling performance and mechanical properties of the electrochemical device, and ensuring the electrochemical device maintains good energy density.

In an embodiment of the present application, 2≤h≤4. Controlling the thickness h of the bonding layer within the scope of the present application is conducive to improving the liquid retention capacity of the separator, enhancing the uniformity of electrolyte distribution, improving the stiffness of the separator, increasing the contact area between the separator and the positive electrode sheet, enhancing the adhesion force between the separator and the positive electrode sheet, further improving the cycling performance of the electrochemical device, and ensuring the electrochemical device maintains good energy density.

In an embodiment of the present application, the material of the bonding layer is selected from at least one of polyvinylidene fluoride, acrylonitrile, methyl methacrylate, or polyurethane. With the material of the bonding layer within the scope of the present application, the adhesion force between the separator and the positive electrode sheet is improved, further enhancing the cycling performance of the electrochemical device.

In an embodiment of the present application, the surface roughness of the separator is Ra nm, 6×S≤Ra≤200×S. By controlling the surface roughness of the separator within the scope of the present application, the contact area between the separator and the positive electrode sheet is increased, the adhesion force between the two is enhanced, the possibility of cycling capacity drop issues is reduced, and the cycling performance of the electrochemical device is further improved.

In an embodiment of the present application, 10≤Ra≤20. By controlling the surface roughness of the separator within the scope of the present application, the contact area between the separator and the positive electrode sheet is increased, the adhesion force between the two is enhanced, the possibility of cycling capacity drop issues is reduced, and the cycling performance of the electrochemical device is further improved.

In an embodiment of the present application, the adhesion force between the positive electrode sheet and the separator is F N/m, 20≤F≤30. With the adhesion force F between the positive electrode sheet and the separator within the scope of the present application, the adhesion between the positive electrode sheet and the separator is improved, thereby reducing the possibility of cycling capacity drop issues and further enhancing the cycling performance of the electrochemical device.

In an embodiment of the present application, the positive electrode active material is selected from at least one of lithium cobalt oxide, lithium iron phosphate, or ternary materials.

A second aspect of the present application provides an electronic device, which includes the electrochemical device described in the first aspect of the present application. The electronic device with the above structure can improve cycling performance.

### Beneficial Effects of the Present Application

The present application provides an electrochemical device, which includes a positive electrode sheet, a negative electrode sheet, and a separator. The positive electrode sheet includes a positive electrode current collector and a positive electrode material layer disposed on at least one surface of the positive electrode current collector, where the positive electrode material layer includes a positive electrode active material. The positive electrode sheet is provided with a plurality of protrusions spaced apart from each other. The height of the protrusions is H m, 20≤H≤80; the radius of the protrusions is R mm, 0.3≤R≤10; the surface area of the protrusions is S mm², 0.08≤S≤2.51; and the protrusions are formed by a portion of the positive electrode sheet protruding on one side along the thickness direction. The electrochemical device with the above structure can increase the contact area between the separator and the positive electrode sheet, improve the adhesion between the separator and the positive electrode sheet, reduce the possibility of cycling capacity drop issues, and thereby improve the cycling performance of the electrochemical device. The structural parameters of the protrusions within the scope of the present application can reduce damage caused by the protrusions to the separator and the positive electrode sheet, lower the risk of electrolyte leakage and increased internal resistance, and improve the service life and safety performance of the electrochemical device.

Certainly, implementing any product or method of the present application does not necessarily achieve all the advantages mentioned above simultaneously.

### DESCRIPTION OF THE DRAWINGS

To more clearly illustrate the technical solutions in some embodiments of the present application, the drawings used in the description of these embodiments are briefly introduced below. Obviously, the drawings described below are only some embodiments of the present application. For those of ordinary skill in the art, other embodiments can also be obtained based on these drawings.

FIG. 1 is a schematic structural diagram of a lithium-ion battery prepared in Example 1 of the present application;

FIG. 2 is a partially enlarged schematic structural diagram at position A in FIG. 1;

FIG. 3 is a schematic structural diagram of protrusions of a positive electrode sheet prepared in Example 1 of the present application; and

FIG. 4 is a schematic structural diagram of protrusions of a positive electrode sheet prepared in Example 1 of the present application.

### DETAILED DESCRIPTION

The technical solutions in the present application will be described clearly and completely below in conjunction with some embodiments and drawings of the present application. Obviously, the described embodiments are only some embodiments of the present application, rather than all embodiments. All other embodiments obtained by those skilled in the art based on the present application fall within the scope of protection of the present application.

It should be noted that, in the detailed description of the present application, a lithium-ion battery is used as an example of an electrochemical device to explain the present application. However, the electrochemical device of the present application is not limited to lithium-ion batteries. The specific technical solutions are as follows:

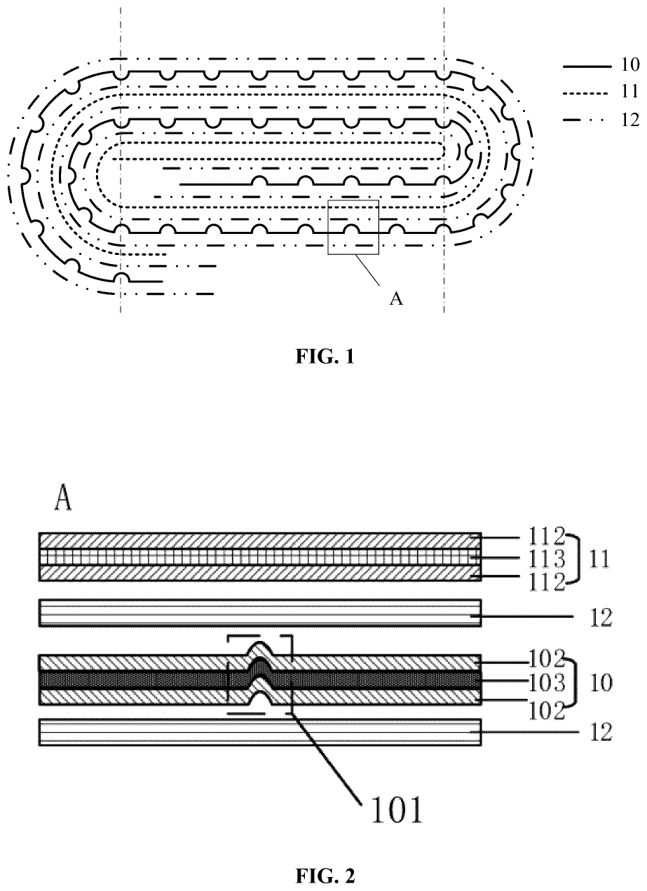

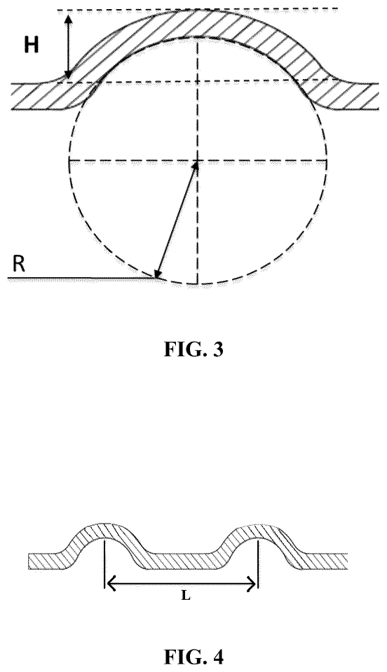

A first aspect of the present application provides an electrochemical device, which includes a positive electrode sheet, a negative electrode sheet, and a separator. The positive electrode sheet includes a positive electrode current collector and a positive electrode material layer disposed on at least one surface of the positive electrode current collector, where the positive electrode material layer includes a positive electrode active material. The positive electrode sheet is provided with a plurality of protrusions spaced apart from each other. A height of the protrusions is H m, 20≤H≤80; a radius of the protrusions is R mm, 0.3≤R≤10; a surface area of the protrusions is S mm², 0.08≤S≤2.51; and the protrusions are formed by a portion of the positive electrode sheet protruding on one side along the thickness direction. As shown in FIG. 1 and FIG. 2, the electrochemical device includes a positive electrode sheet 10, a negative electrode sheet 11, and a separator 12. The positive electrode sheet 10 includes a positive electrode current collector 103 and a positive electrode material layer 102 disposed on both surfaces of the positive electrode current collector 103. The positive electrode sheet 10 is provided with protrusions 101. The negative electrode sheet includes a negative electrode current collector 113 and a negative electrode material layer 112 disposed on both surfaces of the negative electrode current collector 113. As shown in FIG. 3, the height H of the protrusion refers to the height of the highest point of the protrusion on the positive electrode sheet above the horizontal plane of the positive electrode sheet. For example, the height H of the protrusion can be 20 μm, 25 μm, 30 μm, 35 μm, 40 μm, 45 μm, 50 μm, 55 μm, 60 μm, 65 μm, 70 μm, 75 μm, 80 μm, or a range composed of any two of these values; the radius R can be 0.3 mm, 1 mm, 2 mm, 3 mm, 4 mm, 5 mm, 6 mm, 7 mm, 8 mm, 9 mm, 10 mm, or a range composed of any two of these values; and the surface area S can be 0.08 mm², 0.1 mm², 0.5 mm², 1 mm², 1.5 mm², 2 mm², 2.51 mm², or a range composed of any two of these values. The electrochemical device with the above structure can increase the contact area between the separator and the positive electrode sheet, improve the adhesion force between the separator and the positive electrode sheet, reduce the possibility of cycling capacity drop issues, and improve the cycling performance of the electrochemical device. The structural parameters of the protrusions within the scope of the present application can reduce damage caused by the protrusions to the separator and the positive electrode sheet, lower the risk of electrolyte leakage and increased internal resistance, and improve the service life and safety performance of the electrochemical device.

In the present application, the surface area S of the protrusion refers to the surface area formed by the protrusion of a portion of the positive electrode sheet on one side along the thickness direction.

In an embodiment of the present application, 0.3≤R≤8. For example, the radius R can be 0.3 mm, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, or a range composed of any two of these values. By controlling the radius R of the protrusions within the scope of the present application, the cycling performance, service life, and safety performance of the electrochemical device are further improved.

In an embodiment of the present application, the spacing between two adjacent protrusions is L mm, 0.5 mm≤L≤4 mm. For example, the spacing L between two adjacent protrusions can be 0.5 mm, 1 mm, 1.5 mm, 2 mm, 2.5 mm, 3 mm, 3.5 mm, 4 mm, or a range composed of any two of these values. As shown in FIG. 4, the spacing between the highest points of two adjacent protrusions is L. By controlling the spacing L between two adjacent protrusions within the scope of the present application, damage caused by the protrusions to the separator and the positive electrode sheet is reduced, while the positive electrode sheet maintains sufficient strength, lowering the risk of electrolyte leakage and further improving the service life and safety performance of the electrochemical device. Additionally, it increases the contact area between the separator and the positive electrode sheet, enhances the adhesion force between the separator and the positive electrode sheet, reduces the possibility of cycling capacity drop issues, and further improves the cycling performance of the electrochemical device.

In an embodiment of the present application, the separator includes a base film, a ceramic layer, and a bonding layer, where the ceramic layer is located between the base film and the bonding layer, and the thickness of the bonding layer is h μm, 0.7≤h/S≤40. For example, the value of h/S can be 0.7, 1, 2, 4, 6, 8, 10, 12, 14, 16, 18, 20, 22, 24, 26, 28, 30, 32, 34, 36, 38, 40, or a range composed of any two of these values. By controlling the thickness h of the bonding layer within the scope of the present application, the liquid retention capacity of the separator can be improved, the uniformity of electrolyte distribution can be improved, and the stiffness of the separator can be improved, thereby increasing the contact area between the separator and the protrusions of the positive electrode sheet, enhancing the adhesion force between the separator and the positive electrode sheet, further improving the cycling performance and mechanical properties of the electrochemical device, and ensuring the electrochemical device maintains good energy density.

In an embodiment of the present application, 2≤h≤4. For example, the thickness h of the bonding layer can be 2 μm, 2.2 μm, 2.5 μm, 2.8 μm, 3 μm, 3.2 μm, 3.5 μm, 3.8 μm, 4 μm, or a range composed of any two of these values. Controlling the thickness h of the bonding layer within the scope of the present application is conducive to improving the liquid retention capacity of the separator, improving the uniformity of electrolyte distribution, improving the stiffness of the separator, increasing the contact area between the separator and the positive electrode sheet, enhancing the adhesion force between the separator and the positive electrode sheet, further improving the cycling performance of the electrochemical device, and ensuring the electrochemical device maintains good energy density.

In an embodiment of the present application, the material of the bonding layer is selected from at least one of polyvinylidene fluoride, acrylonitrile, methyl methacrylate, or polyurethane. With the material of the bonding layer within the scope of the present application, the adhesion force between the separator and the positive electrode sheet is improved, further enhancing the cycling performance of the electrochemical device.

In some embodiments of the present application, the base film may be a non-woven fabric or a composite film with a porous structure, and the material of the base film may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used.

In some embodiments of the present application, at least one surface of the base film is provided with a ceramic layer and a bonding layer. The ceramic layer is located between the base film and the bonding layer. The term “at least one surface” means that the ceramic layer and the bonding layer may be disposed on one surface of the base film along its thickness direction, or on both surfaces of the base film along its thickness direction. It should be noted that the “surface” here may refer to the entire region of the base film surface or a partial region of the base film surface, and the present application is not particularly limited as long as the purpose of the present application can be achieved.

In some embodiments of the present application, the ceramic layer includes ceramic particles and a ceramic layer binder. The present application is not particularly limited to the ceramic particles. For example, the ceramic particles may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The present application is not particularly limited to the ceramic layer binder as long as the purpose of the present application can be achieved. For example, the ceramic layer binder may include, but is not limited to, at least one of polyacrylic acid, sodium polyacrylate, potassium polyacrylate, lithium polyacrylate, polyimide, polyvinyl alcohol, carboxymethyl cellulose, sodium carboxymethyl cellulose, lithium carboxymethyl cellulose, polyimide, polyamide-imide, styrene-butadiene rubber, or polyvinylidene fluoride.

In the present application, the thickness of the separator may be from 4 μm to 50 μm. The thickness of the base film may be from 2.5 μm to 30 μm, and the thickness of the ceramic layer may be from 0.5 μm to 5 μm.

In an embodiment of the present application, the surface roughness of the separator is Ra nm, 6×S≤Ra≤200×S. For example, the surface roughness Ra of the separator can be 6S, 8S, 10S, 12S, 14S, 16S, 18S, 20S, 40S, 60S, 80S, 100S, 120S, 140S, 160S, 180S, 200S, or a range composed of any two of these values. By controlling the surface roughness of the separator within the scope of the present application, the contact area between the separator and the positive electrode sheet is increased, the adhesion force between the two is enhanced, the possibility of cycling capacity drop issues is reduced, and the cycling performance of the electrochemical device is further improved.

In an embodiment of the present application, 10≤Ra≤20. For example, the surface roughness Ra of the separator can be 10 nm, 12 nm, 14 nm, 16 nm, 18 nm, 20 nm, or a range composed of any two of these values. By controlling the surface roughness of the separator within the scope of the present application, the contact area between the separator and the positive electrode sheet is increased, the adhesion force between the two is enhanced, the possibility of cycling capacity drop issues is reduced, and the cycling performance of the electrochemical device is further improved.

In an embodiment of the present application, the adhesion force between the positive electrode sheet and the separator is F N/m, 20≤F≤30. For example, the adhesion force F between the positive electrode sheet and the separator can be 20 N/m, 21 N/m, 22 N/m, 23 N/m, 24 N/m, 25 N/m, 26 N/m, 27 N/m, 28 N/m, 29 N/m, 30 N/m, or a range composed of any two of these values. With the adhesion force F between the positive electrode sheet and the separator within the scope of the present application, the adhesion between the positive electrode sheet and the separator is improved, thereby reducing the possibility of cycling capacity drop issues and further enhancing the cycling performance of the electrochemical device.

In the present application, the height H and radius R of the protrusions can be adjusted by controlling the structure of the rolling equipment.

In the present application, the surface area S of the protrusions can be adjusted by controlling the structure and pressure of the rolling equipment.

In the present application, the spacing L between two adjacent protrusions can be adjusted by controlling the structure of the rolling equipment.

The present application is not particularly limited to the method of adjusting the surface roughness Ra of the separator as long as the purpose of the present application can be achieved. For example, the surface roughness Ra of the separator can be adjusted by controlling the material of the bonding layer or the coating process parameters of the bonding layer.

The present application is not particularly limited to the method of adjusting the adhesion force F between the positive electrode sheet and the separator as long as the purpose of the present application can be achieved. For example, the adhesion force F between the positive electrode sheet and the separator can be adjusted by controlling the height H, radius R, and surface area S of the protrusions.

In an embodiment of the present application, the positive electrode active material is selected from at least one of lithium cobalt oxide, lithium iron phosphate, or ternary materials.

In the present application, the term “positive electrode material layer disposed on at least one surface of the positive electrode current collector” means that the positive electrode material layer may be disposed on one surface of the positive electrode current collector along its thickness direction, or on both surfaces of the positive electrode current collector along its thickness direction. It should be noted that the “surface” here may refer to the entire region of the positive electrode current collector surface or a partial region of the positive electrode current collector surface, and the present application is not particularly limited as long as the purpose of the present application can be achieved.

The present application is not particularly limited to the positive electrode current collector as long as the purpose of the present application can be achieved. For example, it may include aluminum foil, aluminum alloy foil, or a composite electrode current collector (for example, an aluminum-carbon composite current collector).

The positive electrode material layer may further include a positive electrode conductive agent and a positive electrode binder. The present application is not particularly limited to the types of the positive electrode conductive agent and the positive electrode binder as long as the purpose of the present application can be achieved. For example, the positive electrode conductive agent may include, but is not limited to, at least one of conductive carbon black (Super P), carbon nanotubes (CNTs), carbon fibers, flake graphite, graphene, metal materials, or conductive polymers. The conductive carbon black may include, but is not limited to, at least one of acetylene black or Ketjen black. The carbon nanotubes may include, but are not limited to, single-walled carbon nanotubes and/or multi-walled carbon nanotubes. The carbon fibers may include, but are not limited to, vapor-grown carbon fibers (VGCF) and/or nano carbon fibers. The metal materials may include, but are not limited to, metal powder and/or metal fibers. Specifically, the metal may include, but is not limited to, at least one of copper, nickel, aluminum, or silver. The conductive polymers may include, but are not limited to, at least one of polyphenylene derivatives, polyaniline, polythiophene, polyacetylene, or polypyrrole.

The present application is not particularly limited to the positive electrode binder as long as the purpose of the present application can be achieved. For example, the positive electrode binder may include, but is not limited to, at least one of polyacrylic acid, sodium polyacrylate, potassium polyacrylate, lithium polyacrylate, polyimide, polyvinyl alcohol, carboxymethyl cellulose, sodium carboxymethyl cellulose, lithium carboxymethyl cellulose, polyimide, polyamide-imide, styrene-butadiene rubber, or polyvinylidene fluoride.

In the present application, the thickness of the positive electrode current collector is from 5 μm to 20 μm, and the thickness of the double-sided positive electrode material layer is from 50 μm to 120 μm. Optionally, the positive electrode sheet may further include a positive electrode conductive layer, where the positive electrode conductive layer is located between the positive electrode current collector and the positive electrode material layer. The composition of the positive electrode conductive layer is not particularly limited and may be a conductive layer commonly used in the art. The positive electrode conductive layer includes a positive electrode conductive layer conductive agent and a positive electrode conductive layer binder. The present application is not particularly limited to the positive electrode conductive layer conductive agent and the positive electrode conductive layer binder. For example, they may be at least one of the positive electrode conductive agents and positive electrode binders mentioned above.

In the present application, the preparation process of the positive electrode sheet includes, but is not limited to: mixing the positive electrode active material, positive electrode binder, and positive electrode conductive agent in a mass ratio of (95-98):(0.8-2):(1-3) to form a positive electrode slurry, applying the positive electrode slurry on both surfaces of the positive electrode current collector, and drying it to form the positive electrode sheet; then using a protrusion roller designed based on the protrusion parameters for rolling, adjusting the pressure of the rolling equipment to 15-25 MPa, and setting the rolling temperature to room temperature and humidity to 5%-10%.

In the present application, the negative electrode sheet includes a negative electrode current collector and a negative electrode material layer disposed on at least one surface of the negative electrode current collector. The term “negative electrode material layer disposed on at least one surface of the negative electrode current collector” means that the negative electrode material layer may be disposed on one surface of the negative electrode current collector along its thickness direction, or on both surfaces of the negative electrode current collector along its thickness direction. It should be noted that the “surface” here may refer to the entire region of the negative electrode current collector surface or a partial region of the negative electrode current collector surface, and the present application is not particularly limited as long as the purpose of the present application can be achieved.

The present application is not particularly limited to the negative electrode current collector as long as the purpose of the present application can be achieved. For example, it may include copper foil, copper alloy foil, nickel foil, stainless steel foil, titanium foil, nickel foam, copper foam, or a composite current collector. Exemplarily, the composite electrode current collector may be a lithium-copper composite current collector, a carbon-copper composite current collector, a nickel-copper composite current collector, a titanium-copper composite current collector, or the like.

The negative electrode material layer includes a negative electrode active material. The present application is not particularly limited to the negative electrode active material as long as the purpose of the present application can be achieved. For example, the negative electrode active material may include, but is not limited to, at least one of natural graphite, artificial graphite, mesocarbon microbeads, hard carbon, soft carbon, silicon, silicon-carbon composites, Li—Sn alloys, Li—Sn—O alloys, Sn, SnO, SnO₂, spinel-structured lithiated TiO₂—Li₄Ti₅O₁₂, or Li—Al alloys.

In some embodiments of the present application, the negative electrode material layer may further include a negative electrode conductive agent and a negative electrode binder. The present application is not particularly limited to the types of the negative electrode conductive agent and the negative electrode binder as long as the purpose of the present application can be achieved. For example, they may be at least one of the negative electrode conductive agents and negative electrode binders mentioned above. The present application is not particularly limited to the mass ratio of the negative electrode active material, negative electrode conductive agent, and negative electrode binder in the negative electrode material layer, and those skilled in the art can choose according to actual needs as long as the purpose of the present application can be achieved.

The present application is not particularly limited to the thickness of the negative electrode material layer as long as the purpose of the present application can be achieved. For example, the thickness of the double-sided negative electrode material layer may be from 30 μm to 120 km.

The present application is not particularly limited to the thickness of the negative electrode current collector as long as the purpose of the present application can be achieved. For example, the thickness of the negative electrode current collector may be from 4 μm to 15 km.

Optionally, the negative electrode sheet may further include a negative electrode conductive layer, where the negative electrode conductive layer is located between the negative electrode current collector and the negative electrode material layer. The present application is not particularly limited to the composition of the negative electrode conductive layer, and it may be a conductive layer commonly used in the art. For example, the negative electrode conductive layer includes a negative electrode conductive layer conductive agent and a negative electrode conductive layer binder. The present application is not particularly limited to the negative electrode conductive layer conductive agent and the negative electrode conductive layer binder. For example, they may be at least one of the positive electrode conductive agents and positive electrode binders mentioned above.

In the present application, the electrochemical device further includes an electrolyte, where the electrolyte includes a lithium salt and a non-aqueous solvent.

The present application is not particularly limited to the lithium salt as long as the purpose of the present application can be achieved. For example, the lithium salt may include, but is not limited to, at least one of lithium hexafluorophosphate (LiPF₆), lithium tetrafluoroborate (LiBF₄), lithium hexafluoroarsenate (LiAsF₆), lithium perchlorate (LiClO₄), lithium tetraphenylborate (LiB(C₆H₅)₄), lithium methanesulfonate (LiCH₃SO₃), lithium trifluoromethanesulfonate (LiCF₃SO₃), lithium bis(trifluoromethanesulfonyl)imide (LiN(SO₂CF₃)₂), lithium tris(trifluoromethanesulfonyl)methide (LiC(SO₂CF₃)₃), lithium hexafluorosilicate (LiSiF₆), lithium bis(oxalate)borate (LiBOB), or lithium difluoro(oxalate)borate (LiF₂OB). The present application is not particularly limited to the content of the lithium salt in the electrolyte as long as the purpose of the present application can be achieved.

The present application is not particularly limited to the non-aqueous solvent as long as the purpose of the present application can be achieved. For example, the non-aqueous solvent may include, but is not limited to, at least one of carbonate compounds, carboxylate compounds, ether compounds, or other organic solvents.

The carbonate compounds may include, but are not limited to, at least one of chain carbonate compounds, cyclic carbonate compounds, or fluorinated carbonate compounds. The chain carbonate compounds may include, but are not limited to, at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The cyclic carbonates may include, but are not limited to, at least one of ethylene carbonate (EC), propylene carbonate (PC), butylene carbonate (BC), or vinyl ethylene carbonate (VEC). The fluorinated carbonate compounds may include, but are not limited to, at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethyl ethylene carbonate. The carboxylate compounds may include, but are not limited to, at least one of methyl formate, methyl acetate, ethyl acetate, n-propyl acetate, tert-butyl acetate, methyl propionate, ethyl propionate, propyl propionate, γ-butyrolactone, decalactone, valerolactone, or caprolactone. The ether compounds may include, but are not limited to, at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. The present application is not particularly limited to the content of the non-aqueous solvent in the electrolyte as long as the purpose of the present application can be achieved.

The electrochemical device further includes a housing for accommodating the positive electrode sheet, separator, negative electrode sheet, and electrolyte, as well as other components known in the field of electrochemical devices. The present application is not limited to the aforementioned other components. The present application is not particularly limited to the housing, and it may be a housing known in the art as long as the purpose of the present application can be achieved. For example, the housing may be a hard shell housing or a flexible housing. The material of the hard shell housing may be metal, and the present application is not limited to the type of metal. Any metal hard shell housing known in the art may be used as long as the purpose of the present application can be achieved. The flexible housing may be a metal-plastic film, such as an aluminum-plastic film or a steel-plastic film.

The present application is not particularly limited to the type of electrochemical device, and it may include any device that undergoes an electrochemical reaction. In the present application, the electrochemical device may include, but is not limited to, lithium metal secondary batteries, lithium-ion secondary batteries (lithium-ion batteries), lithium polymer secondary batteries, or lithium-ion polymer secondary batteries (lithium-ion polymer batteries).

The preparation process of the electrochemical device of the present application is well-known to those skilled in the art, and the present application is not particularly limited. For example, the preparation process of the electrochemical device may include, but is not limited to, the following steps: stacking the positive electrode sheet, separator, and negative electrode sheet in sequence, and winding or folding them as needed to obtain an electrode assembly with a jelly-roll structure, placing the electrode assembly into a housing, injecting the electrolyte into the housing, and sealing it to obtain the electrochemical device; or the following steps: stacking the positive electrode sheet, separator, and negative electrode sheet in sequence, then fixing the four corners of the entire laminated structure with a tape to obtain an electrode assembly with a laminated structure, placing the electrode assembly into a housing, injecting the electrolyte into the housing, and sealing it to obtain the electrochemical device. Additionally, overcurrent protection elements, guide plates, and the like may be placed in the housing as needed to prevent internal pressure build-up and overcharge/discharge in the electrochemical device.

A second aspect of the present application provides an electronic device, which includes the electrochemical device described in the first aspect of the present application.

The present application is not particularly limited to the type of electronic device, and it may be any electronic device known in the prior art. In some embodiments of the present application, the electronic device may include, but is not limited to, notebook computers, pen-input computers, mobile computers, e-book readers, portable phones, portable fax machines, portable copiers, portable printers, head-mounted stereo headphones, video recorders, LCD TVs, handheld cleaners, portable CD players, mini discs, transceivers, electronic notebooks, calculators, memory cards, portable recorders, radios, backup power supplies, motors, automobiles, motorcycles, electric bicycles, bicycles, lighting fixtures, toys, game consoles, clocks, power tools, flashlights, cameras, large household batteries, and lithium-ion capacitors.

### EXAMPLES

Hereinafter, examples and comparative examples are provided to describe the embodiments of the present application in more detail. Various tests and evaluations are conducted according to the methods described below. Unless otherwise specified, “parts” and “%” are based on mass.

### Test Methods and Equipment:

### Test for a Height H, Radius R, Surface Area S of a Protrusion, and a Spacing L Between Two Adjacent Protrusions:

A lithium-ion battery was charged at a constant current of 2C to 4.5 V, then was charged at a constant voltage of 4.5 V until the current reached 0.05C, was left standing for 5 min, and then was discharged at a constant current of 0.5C to 3.0 V. The lithium-ion battery was then disassembled, and a positive electrode sheet with a positive electrode material layer on its surface was taken out.

The positive electrode sheets of the examples and comparative examples were cut longitudinally along the thickness direction using plasma to obtain a flat cross-section. The cross-section was characterized using a Philips XL-30 field emission scanning electron microscope (SEM) at a magnification of 300×. The height and chord length of the protrusions were observed and measured under the microscope. Based on the height H of the protrusion and the chord length of the protrusion, where the chord length of the protrusion is the diameter of the projected area of the protrusion on the electrode sheet, the radius of the spherical protrusion was calculated using the formula radius R=(4×height H×height H+chord length×chord length)/(8×height H), and it was recorded as radius R.

The positive electrode sheets of the examples and comparative examples were cut longitudinally along the thickness direction using plasma to obtain a flat cross-section. The cross-section was characterized using a Philips XL-30 field emission SEM at a magnification of 300×. The spacing L between two adjacent protrusions was observed and measured under the microscope.

The surface area S (mm²) of the protrusion was calculated using the spherical cap surface area formula S=2×π×r×R×H/1000, based on the measured protrusion radius and protrusion height.

### Test for a Thickness h of a Bonding Layer of a Separator:

The lithium-ion battery was charged at a constant current of 2C to 4.5 V, then was charged at a constant voltage of 4.5 V until the current reached 0.05C, was left standing for 5 min, and then was discharged at a constant current of 0.5C to 3.0 V. The lithium-ion battery was then disassembled, the separator together with the positive electrode sheet and negative electrode sheet was soaked in DMC for 30 min and ultrasonically cleaned for 10 min, and the separator was removed.

The separators of the examples and comparative examples were cut longitudinally along the thickness direction using plasma to obtain a flat cross-section. The cross-section was characterized using a Philips XL-30 field emission SEM at a magnification of 300×. The thickness of the bonding layer of the separator was observed and measured under the microscope at a plurality of points and the average value was taken.

### Test for a Surface Roughness Ra of the Separator:

The lithium-ion battery was charged at a constant current of 2C to 4.5 V, then was charged at a constant voltage of 4.5 V until the current reached 0.05 C, was left standing for 5 min, and was discharged at a constant current of 0.5C to 3.0 V. The lithium-ion battery was then disassembled, the separator together with the positive electrode sheet and negative electrode sheet was soaked in DMC for 30 min and ultrasonically cleaned for 10 min, and the separator was taken out.

A contact surface roughness tester was used to measure the surface roughness Ra. Ten samples with dimensions of 150 mm in length and 10 mm in width were selected and placed flat on the test platform, the measurement speed was set to 0.5 mm/s, the test data was recorded after the equipment completed the test, and the average value was taken as Ra.

### Test for an Adhesion Force Between the Positive Electrode Sheet and the Separator:

The lithium-ion battery was charged at a constant current of 2C to 4.5 V, then was charged at a constant voltage of 4.5 V until the current reached 0.05C, was left standing for 5 min, and was discharged at a constant current of 0.5C to 3.0 V. The lithium-ion battery was then disassembled, only the negative electrode sheet was removed, and the separator and positive electrode sheet were taken out to test the adhesion force.

The 180° peel test method for pressure-sensitive adhesive tape was used, with the specific steps as follows:

(1) The test sample was fixed on a steel plate using double-sided tape, with the sample dimensions being 70 mm in length and 20 mm in width.

(2) A 3M tape was attached to the surface of the separator away from the positive electrode sheet, with the tape dimensions being 15 mm in width and 50 mm in length.

(3) A tensile testing instrument (model Shimadzu AGX-V2) was used to peel the 3M tape at a speed of 100 mm/min at 180°, obtaining the adhesion force between the positive electrode sheet and the separator, with the unit being N/m.

### Test for a 1000-Cycle Capacity Retention Rate:

At a test environment temperature of 25° C., the lithium-ion batteries prepared in the comparative examples and examples were charged at a constant current of 2C to 4.5 V, then were charged at a constant voltage of 4.5 V until the current reached 0.05C, were left standing for 5 min, and were discharged at a constant current of 0.5C until the voltage reached 3.0 V. The discharge capacity of the lithium-ion battery at this time was recorded as C0, and then the lithium-ion batteries were left standing for 5 min, which was considered as one cycle. The above cycle was repeated for 1000 times, the discharge capacity after 1000 cycles was recorded as C1, and the 1000-cycle capacity retention rate (%) was calculated as C1/C0×100%.

### Example 1

### <Preparation of Positive Electrode Sheet>

Positive electrode active material LiCoO₂, positive electrode binder polyvinylidene fluoride, and positive electrode conductive agent Super P were mixed in a mass ratio of 97.6:1.3:1.1, where Super P was acetylene black. N-methylpyrrolidone (NMP) was added as a solvent to prepare a slurry with a solid content of 75 wt %, and the mixture was stirred well under vacuum to obtain a positive electrode slurry. The positive electrode slurry was uniformly applied to one surface of a positive electrode current collector aluminum foil with a thickness of 10 μm, and was dried at 120° C. to obtain a positive electrode sheet with a single surface coated with the positive electrode material layer, where the coating weight of the positive electrode material layer was 267.8 mg/1540 mm². The above steps were repeated on the other surface of the aluminum foil to obtain a positive electrode sheet with two surfaces coated with the positive electrode material layer. After drying at 120° C., cold pressing was performed, then a protrusion roller (H=40 μm, R=3 mm) was used for rolling, and the pressure of the rolling equipment was adjusted to 20 MPa, with the rolling temperature at room temperature and humidity at 7.5%. Then, the sheet was cut and the tabs were welded to obtain a positive electrode sheet with dimensions of 74 mm×867 mm for use. The thickness of the positive electrode material layer on the single surface was 42 μm, and the compacted density of the positive electrode sheet was 4.2 g/cm³; the protrusions were uniformly distributed on the positive electrode sheet.

### <Preparation of Negative Electrode Sheet>

Negative electrode active material artificial graphite, negative electrode binder styrene-butadiene rubber, thickener sodium carboxymethyl cellulose, and conductive carbon black were mixed in a mass ratio of 98:1:0.5:0.5, where the conductive carbon black was acetylene black. Deionized water was added as a solvent to prepare a slurry with a solid content of 45 wt %, and the mixture was stirred well in a vacuum mixer to obtain a negative electrode slurry. The negative electrode slurry was uniformly applied to one surface of a negative electrode current collector copper foil with a thickness of 6 μm, and was dried at 120° C. to obtain a negative electrode sheet with a single surface coated with the negative electrode material layer, where the coating weight of the negative electrode material layer was 142 mg/1540 mm². The above steps were repeated on the other surface of the copper foil to obtain a negative electrode sheet with two surfaces coated with the negative electrode material layer. After drying at 120° C., cold pressing was performed, then the sheet was cut and the tabs were welded to obtain a negative electrode sheet with dimensions of 78 mm×875 mm for use. The thickness of the negative electrode material layer on the single surface was 54.5 μm, and the compacted density of the negative electrode sheet was 1.55 g/cm³.

### <Preparation of Electrolyte>

In an environment with a water content of less than 10 ppm, dimethyl carbonate, diethyl carbonate, and ethylene carbonate were mixed in a mass ratio of 1:1:1 to obtain an organic solvent. Then, the electrolyte salt LiPF₆ was added to the organic solvent and was mixed uniformly to obtain the electrolyte. Based on the mass of the electrolyte, the mass percentage of the electrolyte salt was 12.5%, and the remainder was the organic solvent.

### <Separator>

A polyethylene base film with a thickness of 10 μm was used as the base film of the separator. A 5 μm thick aluminum oxide ceramic layer was applied to one surface of the base film, and then a bonding layer with a weight of 2.5 mg/1540.25 mm² (the single-layer coating thickness h=3 μm of the bonding layer) was applied to the surface of the aluminum oxide ceramic layer away from the base film and on the other surface of the base film, and was dried to obtain a separator. The porosity of the separator was 39%. The coating speed was controlled at 5 m/min, with the temperature at room temperature.

### <Preparation of Lithium-Ion Battery>

The prepared positive electrode sheet, separator, and negative electrode sheet were stacked in sequence, with the separator positioned between the positive electrode sheet and negative electrode sheet to provide isolation, and were wound to obtain an electrode assembly. The electrode assembly was placed into an aluminum-plastic film packaging bag, moisture was removed at 80° C., the prepared electrolyte was injected, and vacuum sealing, standing, formation, degassing, and trimming processes were performed to obtain the lithium-ion battery. The formation upper limit voltage was 4.52 V, the formation temperature was 85° C., and the formation standing time was 2 h.

### Example 2 to Example 15

Except for adjusting the relevant data according to Table 1, the rest was the same as in Example 1. The height H and radius R of the protrusion, and the spacing L between two protrusions were adjusted by modifying the structure of the rolling equipment, as shown in Table 1.

### Example 16 to Example 19

Except for adjusting the coating process parameters of the bonding layer of the separator to achieve the surface roughness of the separator as shown in Table 1, the rest was the same as in Example 1.

### Comparative Example 1

Except for not disposing protrusions in <preparation of positive electrode sheet> and adjusting the relevant data according to Table 1, the rest was the same as in Example 1.

### Comparative Example 2 to Comparative Example 5

Except for adjusting the structure of the rolling equipment to achieve the height H and radius R of the protrusions as shown in Table 1, the rest was the same as in Example 1.

The lithium-ion batteries in the examples and comparative examples are tested, and the preparation parameters and performance parameters of the lithium-ion batteries in each example and comparative example are shown in Table 1.

TABLE 1

| | | | | | | | | | | | Adhesion | |
|---|---|---|---|---|---|---|---|---|---|---|---|---|
| | | | | | | | | | | | force F | |
| | | | | | | | Thickness | | | | between | 1000- |
| | | | | | | | h of | | Surface | | positive | cycle |
| | Positive | | | | | | bonding | | roughness | | electrode | capacity |
| | electrode | Height | Radius | Surface | Spacing | Material of | layer of | | Ra of | | sheet and | retention |
| | active | H | R | area S | L | bonding layer | separator | | separator | | separator | rate |
| | material | (μm) | (mm) | (mm²) | (mm) | of separator | (μm) | h/S | (nm) | Ra/S | (N/m) | (%) |
| Example 1 | Lithium | 40 | 3 | 0.75 | 2 | Polyvinylidene | 3 | 4.0 | 15 | 19.9 | 22.3 | 85.6% |
| | cobalt | | | | | fluoride | | | | | | |
| | oxide | | | | | | | | | | | |
| Example 2 | Lithium | 20 | 3 | 0.38 | 2 | Polyvinylidene | 3 | 8.0 | 15 | 39.8 | 30 | 89.9% |
| | cobalt | | | | | fluoride | | | | | | |
| | oxide | | | | | | | | | | | |
| Example 3 | Lithium | 80 | 3 | 1.51 | 2 | Polyvinylidene | 3 | 2.0 | 15 | 9.9 | 21.2 | 85.2% |
| | cobalt | | | | | fluoride | | | | | | |
| | oxide | | | | | | | | | | | |
| Example 4 | Lithium | 40 | 0.3 | 0.08 | 2 | Polyvinylidene | 3 | 39.8 | 15 | 198.9 | 21.6 | 85.4% |
| | cobalt | | | | | fluoride | | | | | | |
| | oxide | | | | | | | | | | | |
| Example 5 | Lithium | 40 | 5 | 1.26 | 2 | Polyvinylidene | 3 | 2.4 | 15 | 11.9 | 27.3 | 87.3% |
| | cobalt | | | | | fluoride | | | | | | |
| | oxide | | | | | | | | | | | |
| Example 6 | Lithium | 40 | 8 | 2.0 | 2 | Polyvinylidene | 3 | 1.5 | 15 | 7.5 | 21.3 | 85.0% |
| | cobalt | | | | | fluoride | | | | | | |
| | oxide | | | | | | | | | | | |
| Example 7 | Lithium | 40 | 10 | 2.51 | 2 | Polyvinylidene | 3 | 1.2 | 15 | 6.0 | 20 | 84.6% |
| | cobalt | | | | | fluoride | | | | | | |
| | oxide | | | | | | | | | | | |
| Example 8 | Lithium | 40 | 3 | 0.75 | 0.5 | Polyvinylidene | 3 | 4.0 | 15 | 19.9 | 20.2 | 84.6% |
| | cobalt | | | | | fluoride | | | | | | |
| | oxide | | | | | | | | | | | |
| Example 9 | Lithium | 40 | 3 | 0.75 | 4 | Polyvinylidene | 3 | 4.0 | 15 | 19.9 | 21.3 | 85.2% |
| | cobalt | | | | | fluoride | | | | | | |
| | oxide | | | | | | | | | | | |
| Example 10 | Lithium | 40 | 3 | 0.75 | 2 | Polyvinylidene | 3 | 4.0 | 15 | 19.9 | 22 | 85.2% |
| | iron | | | | | fluoride | | | | | | |
| | phosphate | | | | | | | | | | | |
| Example 11 | Lithium | 40 | 3 | 0.75 | 2 | Acrylonitrile | 3 | 4.0 | 14 | 18.6 | 21.5 | 85.3% |
| | cobalt | | | | | | | | | | | |
| | oxide | | | | | | | | | | | |
| Example 12 | Lithium | 40 | 3 | 0.75 | 2 | Polyvinylidene | 0.53 | 0.7 | 15 | 19.9 | 20 | 85.0% |
| | cobalt | | | | | fluoride | | | | | | |
| | oxide | | | | | | | | | | | |
| Example 13 | Lithium | 40 | 3 | 0.75 | 2 | Polyvinylidene | 2 | 2.7 | 15 | 19.9 | 22 | 85.4% |
| | cobalt | | | | | fluoride | | | | | | |
| | oxide | | | | | | | | | | | |
| Example 14 | Lithium | 40 | 3 | 0.75 | 2 | Polyvinylidene | 4 | 5.3 | 15 | 19.9 | 28.6 | 90.2% |
| | cobalt | | | | | fluoride | | | | | | |
| | oxide | | | | | | | | | | | |
| Example 15 | Lithium | 40 | 3 | 0.75 | 2 | Polyvinylidene | 30.16 | 40.0 | 15 | 19.9 | 20.3 | 85.1% |
| | cobalt | | | | | fluoride | | | | | | |
| | oxide | | | | | | | | | | | |
| Example 16 | Lithium | 40 | 3 | 0.75 | 2 | Polyvinylidene | 3 | 4.0 | 4.52 | 6.0 | 20.4 | 84.6% |
| | cobalt | | | | | fluoride | | | | | | |
| | oxide | | | | | | | | | | | |
| Example 17 | Lithium | 40 | 3 | 0.75 | 2 | Polyvinylidene | 3 | 4.0 | 10 | 13.3 | 21.7 | 85.4% |
| | cobalt | | | | | fluoride | | | | | | |
| | oxide | | | | | | | | | | | |
| Example 18 | Lithium | 40 | 3 | 0.75 | 2 | Polyvinylidene | 3 | 4.0 | 20 | 26.5 | 28.3 | 88.6% |
| | cobalt | | | | | fluoride | | | | | | |
| | oxide | | | | | | | | | | | |
| Example 19 | Lithium | 40 | 3 | 0.75 | 2 | Polyvinylidene | 3 | 4.0 | 150.80 | 200.0 | 20.6 | 85.0% |
| | cobalt | | | | | fluoride | | | | | | |
| | oxide | | | | | | | | | | | |
| Comparative | Lithium | / | / | / | / | Polyvinylidene | 3 | / | 15 | / | 10.9 | 74.3% |
| Example 1 | cobalt | | | | | fluoride | | | | | | |
| | oxide | | | | | | | | | | | |
| Comparative | Lithium | 100 | 3 | 1.88 | 2 | Polyvinylidene | 3 | 1.6 | 15 | 8.0 | 15 | 79.2% |
| Example 2 | cobalt | | | | | fluoride | | | | | | |
| | oxide | | | | | | | | | | | |
| Comparative | Lithium | 10 | 3 | 0.19 | 2 | Polyvinylidene | 3 | 15.9 | 15 | 79.6 | 14 | 79.3% |
| Example 3 | cobalt | | | | | fluoride | | | | | | |
| | oxide | | | | | | | | | | | |
| Comparative | Lithium | 40 | 0.1 | 0.03 | 2 | Polyvinylidene | 3 | 119.4 | 15 | 596.8 | 15 | 79.7% |
| Example 4 | cobalt | | | | | fluoride | | | | | | |
| | oxide | | | | | | | | | | | |
| Comparative | Lithium | 40 | 12 | 3.02 | 2 | Polyvinylidene | 3 | 1.0 | 15 | 5.0 | 16 | 80.3% |
| Example 5 | cobalt | | | | | fluoride | | | | | | |
| | oxide | | | | | | | | | | | |

Note:
In Table 1, “/” indicates the absence of corresponding preparation parameters, materials, or performance parameters.

In the electrochemical device, the height H, radius R, and surface area S of the protrusions on the positive electrode sheet affect the cycling performance of the electrochemical device. From Example 1 to Example 19 and Comparative Example 1 to Comparative Example 5, it can be seen that when the positive electrode sheet is provided with a plurality of protrusions spaced apart from each other and the height, radius, and area of the protrusions are within the scope of the present application, the 1000-cycle capacity retention rate of the obtained electrochemical device is higher, indicating that the cycling performance of the electrochemical device is improved.

The spacing L between two adjacent protrusions on the positive electrode sheet affects the cycling performance of the electrochemical device. From Example 1, Example 8, and Example 9, it can be seen that when the spacing L between two adjacent protrusions on the positive electrode sheet is within the scope of the present application, the 1000-cycle capacity retention rate of the obtained electrochemical device is higher, indicating that the cycling performance of the electrochemical device is improved.

The type of positive electrode active material affects the cycling performance of the electrochemical device. From Examples 1 and 10, it can be seen that when the type of positive electrode active material is within the scope of the present application, the 1000-cycle capacity retention rate of the obtained electrochemical device is higher, indicating that the cycling performance of the electrochemical device is improved.

The thickness h and material of the bonding layer of the separator affect the cycling performance of the electrochemical device. From Example 1 and Example 11 to Example 15, it can be seen that when the thickness h and material type of the bonding layer of the separator are within the scope of the present application, the 1000-cycle capacity retention rate of the obtained electrochemical device is higher, indicating that the cycling performance of the electrochemical device is improved.

The value of h/S affects the cycling performance of the electrochemical device. From Example 1 and Example 12 to Example 15, it can be seen that when the value of h/S is within the scope of the present application, the 1000-cycle capacity retention rate of the obtained electrochemical device is higher, indicating that the cycling performance of the electrochemical device is improved.

The surface roughness Ra of the separator affects the cycling performance of the electrochemical device. From Example 1 and Example 16 to Example 19, it can be seen that when the surface roughness Ra of the separator is within the scope of the present application, the 1000-cycle capacity retention rate of the obtained electrochemical device is higher, indicating that the cycling performance of the electrochemical device is improved.

The adhesion force between the positive electrode sheet and the separator is influenced by the height H, radius R, surface area S of the protrusions, the spacing L between two adjacent protrusions, the thickness h of the bonding layer of the separator, and the surface roughness Ra of the separator. From Example 1 to Example 19 and Comparative Examples 1 to 5, it can be seen that when the height H, radius R, surface area S of the protrusions, the spacing L between two adjacent protrusions, the thickness h of the bonding layer of the separator, and the surface roughness Ra of the separator are within the scope of the present application, the adhesion force between the positive electrode sheet and the separator is also within the scope of the present application.

It should be noted that, in this document, relational terms such as first and second are used solely to distinguish one entity or operation from another entity or operation without necessarily requiring or implying any actual such relationship or order between such entities or operations. Moreover, the terms “include”, “comprise”, or any other variation thereof are intended to cover a non-exclusive inclusion, such that a process, method, or article that includes a list of elements does not include only those elements but may include other elements not expressly listed or inherent to such process, method, or article.

The various embodiments in this specification are described in a related manner, and similar or identical parts between some embodiments can be referred to each other. Each embodiment focuses on the differences from other embodiments.

The above descriptions are only preferred embodiments of the present application and are not intended to limit the present application. Any modifications, equivalent replacements, improvements, and the like made within the spirit and principles of the present application should be included within the scope of protection of the present application.

What is claimed is:

1. An electrochemical device, comprising: a positive electrode sheet, a negative electrode sheet, and a separator; wherein the positive electrode sheet comprises a positive electrode current collector and a positive electrode material layer disposed on at least one surface of the positive electrode current collector, and the positive electrode material layer comprises a positive electrode active material; wherein
the positive electrode sheet is provided with a plurality of protrusions spaced apart from each other, a height of the protrusions is H m, wherein 20≤H≤80, a radius of the each protrusions is R mm, wherein 0.3≤R≤10, a surface area of the each protrusions is S mm², wherein 0.08≤S≤2.51, and the protrusions are formed by a portion of the positive electrode sheet protruding on one side along a thickness direction of the positive electrode sheet.

2. The electrochemical device according to claim 1, wherein 0.3≤R≤8.

3. The electrochemical device according to claim 1, wherein a spacing between two adjacent protrusions is L mm, and 0.5 mm≤L≤4 mm.

4. The electrochemical device according to claim 1, wherein the separator comprises a base film, a ceramic layer, and a bonding layer; the ceramic layer is located between the base film and the bonding layer, and a thickness of the bonding layer is h m, and 0.7≤h/S≤40.

5. The electrochemical device according to claim 4, wherein 2≤h≤4.

6. The electrochemical device according to claim 4, wherein a material of the bonding layer is at least one selected from polyvinylidene fluoride, acrylonitrile, methyl methacrylate, or polyurethane.

7. The electrochemical device according to claim 1, wherein a surface roughness of the separator is Ra nm, and 6×S≤Ra≤200×S.

8. The electrochemical device according to claim 7, wherein 10≤Ra≤20.

9. The electrochemical device according to claim 1, wherein an adhesion force between the positive electrode sheet and the separator is F N/m, and 20≤F≤30.

10. The electrochemical device according to claim 1, wherein the positive electrode active material is at least one selected from lithium cobalt oxide, lithium iron phosphate, or ternary materials.

11. An electronic device, comprising the electrochemical device according to claim 1.

12. The electronic device according to claim 11, wherein 0.3≤R≤8.

13. The electronic device according to claim 11, wherein a spacing between two adjacent protrusions is L mm, and 0.5 mm≤L≤4 mm.

14. The electronic device according to claim 11, wherein the separator comprises a base film, a ceramic layer, and a bonding layer; the ceramic layer is located between the base film and the bonding layer, and a thickness of the bonding layer is h μm, and 0.7≤h/S≤40.

15. The electronic device according to claim 14, wherein 2≤h≤4.

16. The electronic device according to claim 14, wherein a material of the bonding layer is at least one selected from polyvinylidene fluoride, acrylonitrile, methyl methacrylate, or polyurethane.

17. The electronic device according to claim 11, wherein a surface roughness of the separator is Ra nm, and 6×S≤Ra≤200×S.

18. The electronic device according to claim 17, wherein 10≤Ra≤20.

19. The electronic device according to claim 11, wherein an adhesion force between the positive electrode sheet and the separator is F N/m, and 20≤F≤30.

20. The electronic device according to claim 11, wherein the positive electrode active material is at least one selected from lithium cobalt oxide, lithium iron phosphate, or ternary materials.
